(19) United States
(12) Patent Application Publication
(10) Pub. No.: US 2005/0139523 A1
(43) Pub. Date: Jun. 30, 2005

(54) Apparatus and method for air classification and drying of particulate matter

(76) Inventor: Thomas Lamar Palmer, Rome, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/007,686

(22) Filed: Dec. 8, 2004

Related U.S. Application Data
(60) Provisional application No. 60/528,413, filed on Dec. 10, 2003.

(51) Int. Cl. B03B 5/62

(52) U.S. Cl. 209/155; 34/372

(57) ABSTRACT

An apparatus for air classification and drying of particulate matter, and method of use thereof, for removal of moisture from particulate matter, wherein the particulate matter is first accelerated to a high velocity and permitted to impinge normally upon a steel plate, or at an angle against a tube wall. Water adsorbed by the particulate matter is atomized and then may be classified and removed via a cyclone separator.

### CROSS-REFERENCES TO RELATED APPLICATIONS AND PRIORITY CLAIM

This non-provisional patent application claims priority to, and the full benefit of, Provisional Application No. 60/528,413, filed Dec. 10, 2003, and entitled “Device and Method for Air Classification and Separation of Water”.

### TECHNICAL FIELD

The present invention relates generally to apparatuses and methods for separation of heterogeneous mixtures, and more specifically to an apparatus for air classification and drying of particulate matter. In particular, the present invention relates to drying solid materials by separation of the aqueous fraction and solid fraction, and removal of the water fractional component by air classification, thereby leaving only dried solids.

### BACKGROUND OF THE INVENTION

Moisture remaining on particulates can interfere with physical and/or chemical processes, most particularly by facilitating packing of the finer particles, leading to formation of clumps. Such clumps can then impede mechanical and chemical processes carried out downstream from the pulverization operation.

Source materials for a variety of applications may be of any size and often must be broken up for use and/or drying. Materials, such as rock, utilized in physical applications, such as roadbeds, usually need not be broken, but only require removal of water. Rock utilized in chemical processes, such as gypsum or cementitious rock, often requires pulverizing to form suitably-sized particles, and usually undergoes a further chemical process prior to use. Processing of grains, such as, for exemplary purposes only, barley and/or other brewers' grains, also often requires the removal of moisture.

Accordingly, there are various apparatuses and associated methods for drying particulate matter. Most commonly, heat, with or without air, may be utilized. Heat applied to particulate matter will raise its temperature, along with that of the bound water, until the vaporization of the water takes place. Vaporized water then departs the surface of the particulate matter and may be removed in an air stream. Although some processes require heat for further processing, such as, for exemplary purposes only, calcining of gypsum or cementitious rock, occasionally, for other materials and/or processes, such as those involving grains, it is undesirable to heat the material due to potential ensuing chemical changes and concurrent product degradation. Further, for those materials that do not require heating for further utilization in a process or product, the addition of heat energy to drive off water unnecessarily increases the cost of the overall process and/or product produced thereby. Additionally, some materials may well be damaged by the addition of heat, and it can be wholly undesirable to degrade the materials in such a fashion. Moreover, in order to facilitate the drying process and to expose a larger surface area to dry and/or heated air, particulate matter is typically broken up into smaller particles. It would be advantageous to utilize only the process of breaking apart of particles, since that would be necessary whether heat is to be utilized or not.

In the course of breaking particulate materials, water that is occluded within the physical structure can be released, thus enabling removal by drying or other subsequent separation method. Moreover, water may often be adsorbed upon surfaces of solid materials and thus a desorption process is necessary to separate and remove the bound water.

Additionally, airflow of a suspension of particles, wherein the particles impinge upon metal bars, has been utilized as a method to break up solid materials. For example, flowing material through breaker bars, knives and/or other blades, either as a solid mass or within a fluid stream will serve to break particles allowing water removal. Because it is typically desired that water be removed, use of an aqueous stream as a carrier would circumvent the purpose of the drying process; thus, the most common fluid, or medium, for suspending particulates is a stream of air. However, such a method is generally suitable for breaking up particles in gross only. Thus, while it may serve to provide various fractions of solid particles having a range of moisture content, and may even release some free water quotient, such a method fails to provide fractions of solids and water vapor, as water particles may continue to adhere to the surface of the solid particles.

As such, cyclones have also been utilized in concert with breaker bars for separation of moisture from solid particles. Breaking apart the solid materials into solid particles via breaker bars takes place prior to introduction of the particles into the cyclone. Typically, a flow of solid particles enters the cyclone, wherein particles having higher mass relative to water are driven to the outside of the cyclone; thereby, classifying and separating layers of finer particulates based on differing specific gravities. The moisture, having been classified by the rotation of air within the cyclone, then exits the center of the cyclone stream due to its lower density. Disadvantageously however, it has not been possible heretofore to completely separate and remove the water fraction, while leaving dry particulate matter behind, as the use of breaker bars does not provide an adequate collision energy to effectively vaporize the moisture.

Considering the above available methods for separating particulate matter, each is disadvantageous when compared to the present invention, as such methods and devices remove only a small portion of the water that is adsorbed on the surface of solid particles.

Accordingly, there is a need for an apparatus and method for air classification and drying of particulate matter, which provides a low energy device and method for removal of water, without modifying the solid matter in an undesirable fashion.

### BRIEF SUMMARY OF THE INVENTION

Briefly described, in a preferred embodiment, the present invention overcomes the above-mentioned disadvantages and meets the recognized need for such an invention by providing an apparatus and method for air classification and drying of particulate matter, by atomizing water, classifying the atomized water and separating the classified atomized water from the particulate matter, wherein the particulate matter is not significantly degraded, and wherein a minimal amount of energy input is required.

According to its major aspects and broadly stated, the present invention in its preferred embodiment is an apparatus and method for air classification and drying of particulate matter, comprising a high-flow rate impingement system, wherein moist particles are impinged upon a steel plate or wall at a sufficiently high speed to cause atomization of water adsorbed on the particulate. The atomized water is subsequently classified within a cyclone and, the atomized water, being lighter than the solid particulate material, is removed; thus, separating the water fraction from the particulate fraction.

More specifically, the present invention enables the suspension of particulate matter within an air flow, wherein impact of the particulate matter, normally upon a steel plate, or at an angle upon a steel wall, causes not only the breakup of particulate matter, but also encourages atomization of the water adsorbed thereon, thus creating a fraction of water vapor for removal via classification. In the preferred form, the classification subsequently occurs within a classification cyclone, wherein the particles, including the water vapor fraction, are circulated rapidly, leading to centrifugal forces acting thereupon. The water vapor, having lower mass, is less affected by the centrifugal forces than are the solid particles. Thus, while the particulate matter accelerates towards the outside of the cyclone, the water molecules decelerate and drift to the center outlet of the cyclone, and are subsequently targeted for removal.

Thus, the present invention, in a generally preferred form, is an apparatus and method for air classification and drying of particulate matter to facilitate separating water from solids, wherein a suspension of solid materials having an undesirably high moisture content is carried by a high velocity airstream, for example, at approximately between 44,000 and 100,000 feet per minute. The airstream parameters are particularly regulated for the material and density of the suspension and the desired atomization of water. The airstream containing moist particulate matter is then impacted against a steel plate to atomize the water, or alternately against the steel walls of a tube carrying high volume low pressure airflow to the cyclone. The level of atomization necessary for separation of water is essentially dependent upon the speed of the material as it impacts against the steel plate or wall. The solids and water then classify in a cyclone, wherein the water fraction, having lower mass, decelerates sooner and exits the center of the cyclone.

Accordingly, a feature and advantage of the present invention is its ability to remove water adsorbed on particulate matter.

Another feature and advantage of the present invention is that it is suitable for drying heat-intolerant materials.

Still another feature and advantage of the present invention is that it can advantageously remove tightly adsorbed water particles from solid matter, thereby drying the solid matter.

Yet another feature and advantage of the present invention is its ability to break apart solid materials.

Yet still another feature and advantage of the present invention is its suitability for drying a variety of different materials.

A further feature and advantage of the present invention is that it does not require additional heat relative to other drying processes.

Yet still a further feature and advantage of the present invention is its suitability for incorporation in many different manufacturing processes.

These and other features and advantages of the present invention will become more apparent to one skilled in the art from the following description and claims when read in light of the accompanying drawings.

### BRIEF DESCRIPTION OF THE DRAWINGS

Having thus described the invention in general terms, the present invention will be better understood by reading the Detailed Description of the Preferred and Selected Alternate Embodiments with reference to the accompanying drawing figures, which are not necessarily drawn to scale, and in which like reference numerals denote similar structures and refer to like elements throughout, and in which:

FIG. 1 is a cross-sectional side view of an apparatus for air classification and drying of particulate matter according to a preferred embodiment of the present invention;

FIG. 2 is a detailed cross-sectional side view of the first stage of an apparatus for air classification and drying of particulate matter according to the preferred embodiment of the present invention shown in FIG. 1;

FIG. 3 is a detailed cross-sectional side view of the second stage cyclone separator component of an apparatus for air classification and drying of particulate matter according to the preferred embodiment of the present invention shown in FIG. 1;

FIG. 4 is a detailed cross-sectional side view of the third stage of an apparatus for air classification and drying of particulate matter according to the preferred embodiment of the present invention shown in FIG. 1; and,

FIG. 5 is a detailed cross-sectional side view of the second stage cyclone separator component shown in FIG. 3 of an apparatus for air classification and drying of particulate matter, according to an alternate embodiment of the present invention.

### DETAILED DESCRIPTION OF THE PREFERRED AND SELECTED ALTERNATE EMBODIMENTS

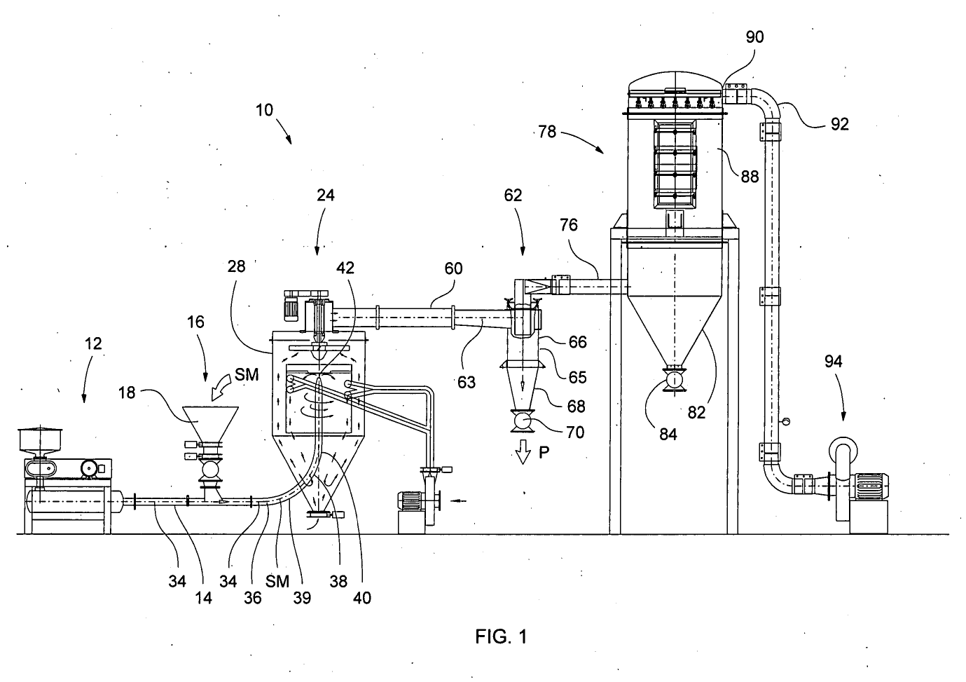

In describing the preferred and selected alternate embodiments of the present invention, as illustrated in FIGS. 1-5, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-4, apparatus 10 for air classification and drying of particulate matter is preferably a multi-stage separator, preferably having a source of high flow rate air, namely, high pressure blower 12, wherein high pressure blower 12 generates air stream 34, and wherein air stream 34 is preferably introduced from high pressure blower 12 via tube 14 to feeder 16. It will be recognized by those skilled in the art that any means for providing a source of high flow rate air could be substituted for high pressure blower 12, such as, for exemplary purposes only, stored air and/or a compressor.

Raw material solid matter SM is preferably introduced to feeder hopper 18 and further conducted via feeder control gates 20 and metering section 22 into air stream 34, preferably downstream from blower 12. Although the term “solid” is utilized to describe the particulate materials undergoing treatment within apparatus 10, the term is utilized herein in a non-limiting fashion to describe a non-aqueous particle; that is, particles treated via apparatus 10 could be semi-solid or otherwise porous, but may include water adsorbed thereon or absorbed therein. As solid matter SM is introduced, a slurry or suspension 36, of particles and air is formed preferably in air stream 34. The concentration, or level, of suspension 36, that is, the ratio of cubic feet of air to pounds of wet material, is important for flow and stability of suspension 36 as is more fully described hereinbelow, wherein the heavier the particle, the higher the rate of flow required to keep it in suspension within air stream 34. Suspension 36 is preferably accelerated to a target velocity, typically approximately between 70,000 and 100,000 feet per minute, by the forced air of air stream 34, wherein the speed of suspension 36 is preferably selected to accommodate the type of material and the density of suspension 36 thereof. A range of between 44,000 feet per minute and 100,000 feet per minute has been found to be suitable for most materials. For example, a more dense material may require a greater velocity and/or a denser quantity of air.

Solid matter SM preferably travels via tube 39, wherein bend 38 is defined in tube 39, enabling continuation as vertical tube 40. Preferably, solid matter SM enters atomizing cyclone 24 at a high velocity, preferably via tip outlet 42, wherein suspension 36 is thereby preferably driven approximately normally against steel plate 44 at a high velocity, preferably at approximately between 70,000 and 100,000 feet per minute. Although a high velocity such as between 70,000 and 100,000 feet per minute is preferred, other higher or lower velocities could be utilized. As solid matter SM impacts against steel plate 44, solid matter SM is preferably broken apart into particulates P, and water previously adsorbed to solid matter SM is preferably atomized by the force of the impact to form atomized water vapor WV. Although it is preferred that plate 44 is steel, other appropriate materials could be utilized, such as other metals, glass or plastics.

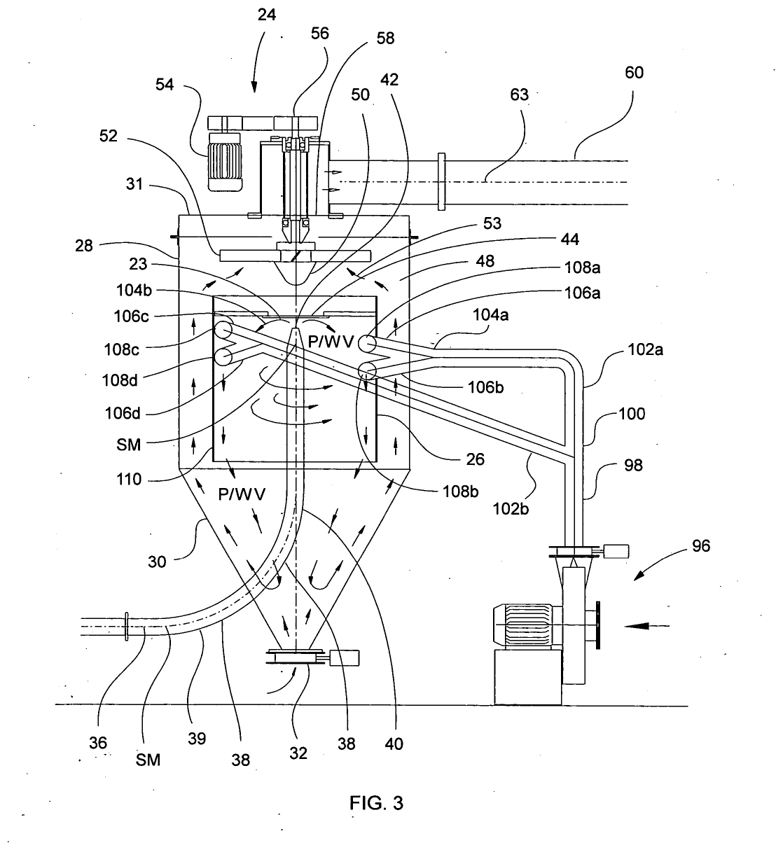

Referring now more particularly to FIG. 3, steel plate 44 is a flat plate located at top 23 of inner cylinder 26 of atomizing cyclone 24, proximate tip outlet 42, wherein flat plate 44 provides a hard surface for impact of particulates exiting tip outlet 42.

Within inner cylinder 26, air preferably flows in a cyclonic fashion. Air from fan 96 passes through tube 98, branch 100, tubes 102a and 102b, branches 104a and 104b, tubes 106a, 106b, 106c and 106d and outlets 108a, 108b, 108c and 108d. Outlets 108a, 108b, 108c and 108d are preferably arranged in pairs 108a and 108b, and 108c and 108d, respectively, on opposing sides of inner cylinder 26, penetrating inner cylinder wall 110, such that outlets 108a, 108b, 108c and 108d preferably face nearly tangentially to the periphery of inner cylinder 26. Air flowing through outlets 108a, 108b, 108c and 108d thus forms a cyclone of air within inner cylinder 26. Other arrangements or means of generating a cyclonic flow of air having an appropriate velocity could alternately be utilized.

Atomizing cyclone 24 preferably has outer cylindrical section 28, inner cylinder 26, conical section 30, top cover 31, damper 32, fan 50 with blades 52 (preferably driven by fan motor 54 via drive 56), and outlet 58 to tube 60 preferably leading to cyclone separator 62. Preferably, air is introduced via damper 32 to flow upward between outer cylindrical section 28 and inner cylinder 26, preferably under influence of fan 50, wherein the flowing air preferably carries particulates P and atomized water vapor WV therewithin.

Air from fan 96 preferably fills lower and upper chambers 46 and 48, respectively, of atomizing cyclone 24. Air from fan 96, pulled by fan 50, preferably travels in a circular fashion, preferably creating a cyclonic updraft within cylindrical section 28 and conical section 30 of atomizing cyclone 24 carrying particulates P and water vapor WV therewithin.

Rotation of fan 50 is preferably designed such that its airflow 53 is exerted in the same direction as the incoming suspension 36, pulling air toward the top of outer cylindrical section 28. Thus, following passage downward out of inner cylinder 26 of atomizing cyclone 24, air is preferably pulled upward by airflow 53 towards fan 50. Upon reaching top cover 31, airflow 53 with suspended particulates P and water vapor WV passes via outlet 58 into tube 60 and then to cyclone 62 as airflow 63.

Airflow 63 preferably enters cyclone 62 via inlet 64, wherein a preferred near tangential orientation of inlet 64 relative to cyclone 62 enables the production of a cyclonic airflow therein. Due to the action of centrifugal force within cyclone 62, and the fact that atomized water vapor WV preferably has a lower specific gravity than particulate matter P from which it was separated, and the higher density particulate matter P preferably drifts to outer wall 65 of cylindrical section 66 of cyclone 62, gradually falling downward through conical section 68, wherein particulate matter P preferably exits cyclone 20 through outlet gate 70 as substantially dry material DM. Water vapor WV, having a lower density than particulate matter PM, is less affected by centrifugal forces and, therefore, drifts to center 71 of cyclone 62. Subsequently, water vapor WV preferably exits cyclone 62 via center pickup 72 through top 74 into tube 76 to baghouse 78.

Water vapor WV entering baghouse 78 preferably condenses therein, wherein water then falls to conical section 82 and is drawn out via air lock 84, or, alternately, water vapor WV passes through top 88 of baghouse 78 via outlet 90 through tube 92, exiting through expelling fan 94. Expelling fan 94 preferably draws air from baghouse 78 and exhausts to the atmosphere.

Preferably, if any residual fine particulates remain mixed within water vapor WV, same are trapped within bag section 80 of collector 86 of baghouse 78 and contained therein. Periodically, bag section 80 of collector 86 is emptied, wherein accumulated fine particulates are removed for disposal or recycling.

It is envisioned in an alternate embodiment that a high speed mixer or beater cyclone may be utilized to ensure an adequate level of suspension through air stream 34.

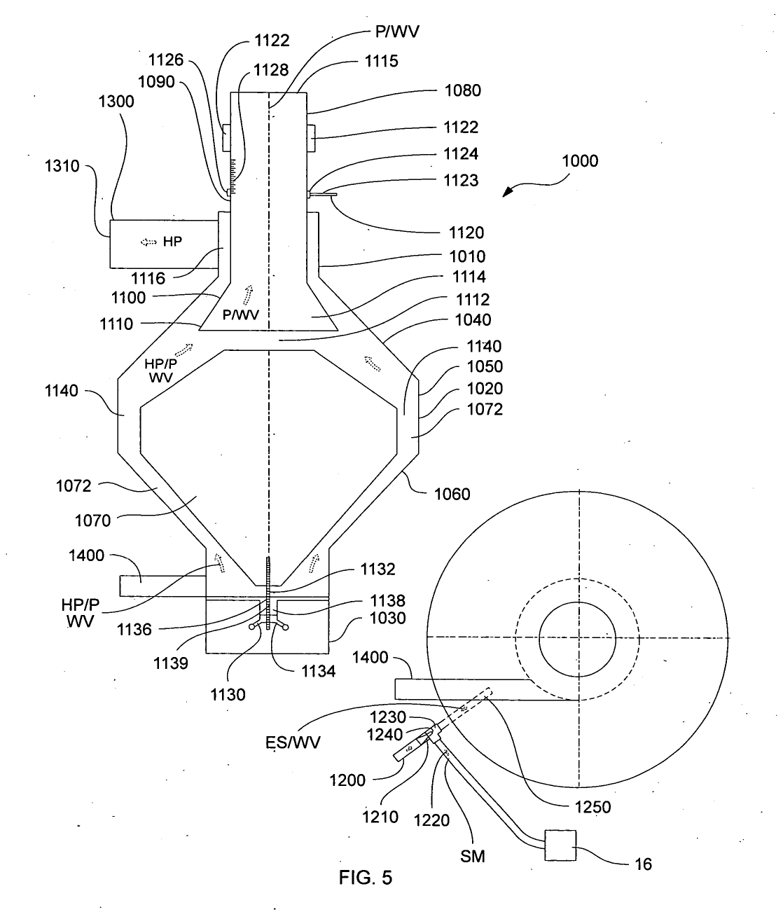

Referring now more specifically to FIG. 5, illustrated therein is an alternate embodiment of atomizing cyclone 24, wherein the alternate embodiment of FIG. 5 is substantially equivalent in form and function to that of the preferred embodiment detailed and illustrated in FIGS. 1-4 except as hereinafter specifically referenced. Specifically, the embodiment of FIG. 5 comprises drying separator 1000, wherein drying separator 1000 comprises top section 1010, middle section 1020 and bottom section 1030. Middle section 1020 comprises upper portion 1040, center portion 1050 and lower portion 1050, wherein upper portion 1040 and lower portion 1050 are conical in shape.

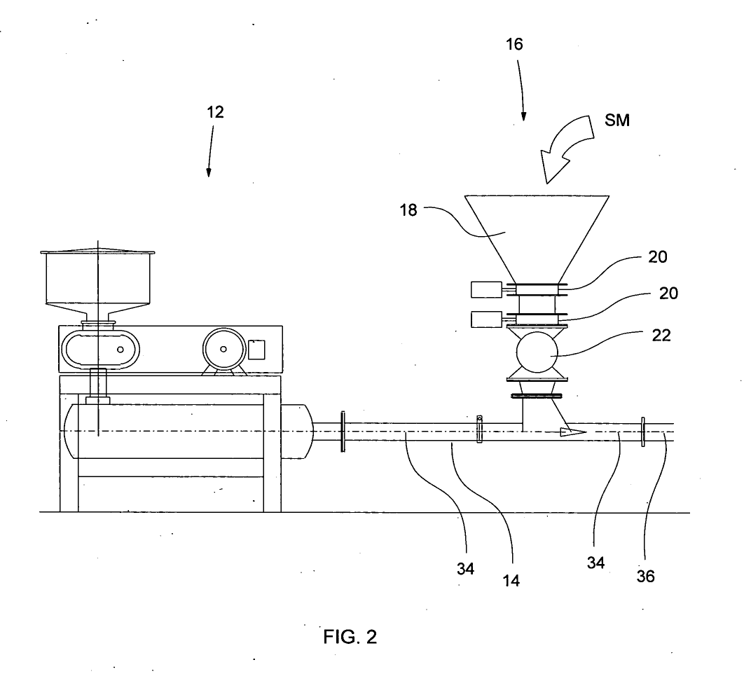

Tube 14 from compressor or blower 12 (best shown in FIGS. 1 and 2) comprises high pressure air at a flow rate of 1,000 feet per minute, wherein air flows through constriction 1210, exiting tube 14 at tip 1230 into chamber 1240. Solid material SM comprising a slurry is pumped via slurry line 1220 from feeder 16 (best shown in FIGS. 1 and 2), wherein feeder 16 comprises a slurry pump (not shown). Solid material SM enters chamber 1240 proximate tip 1230, wherein high velocity air exiting tip 1230 carries solid material SM through nozzle 1250, causing solid material SM to become carried, along with water vapor WV, as entrained solids ES, and wherein entrained solids ES comprises heavy particulates HP and finer particulate matter P.

Nozzle 1250 is disposed within centrifugal air feed 1400, wherein nozzle 1250 is positioned within approximately 1 to 3 inches from, and at an angle of approximately 45 degrees to, wall 1410 of centrifugal air feed 1400. Air at a flow rate of 3000 feet per minute at 4 psi passes through centrifugal air feed 1400 from a high volume air source, such as fan 96, thereby causing a cyclonic effect within bottom section 1030 and middle section 1020 of drying separator 1000. At chamber 1240, wherein air flow meets solid material SM, air flow is 1000 cubic feet/minute at 90 psi and airspeed is between approximately 70,000 to 100,000 feet/minute.

In addition to centrifugal air feed 1400 as depicted in FIG. 5, drying separator 1000 could comprise a second centrifugal air feeder disposed opposite to centrifugal air feeder 1400, wherein a second flow rate of air at 0.3000 feet per minute at 4 psi could facilitate a high cyclonic effect within drying separator 1000.

Conical baffle 1070 is disposed within middle section 1020, wherein conical baffle 1070 can be selectively raised or lowered via adjusting means 1130, and wherein adjusting means 1130 comprises threaded rod 1132 in rigid communication with conical baffle 1070 and adjusting nut 1134. Threaded section 1136 of threaded rod 1132 is retained within block 1138, wherein block 1138 has threads 1139 disposed therewithin, and wherein threads 1039 are adapted to receive threaded rod 1132, thereby permitting adjustment by rotation of adjusting nut 1134. Conical baffle 1070 is selectively adjusted to narrow or widen gap 1072, and gap 1072 is preferably 3.5 inches when drying separator 1000 is utilized for drying of brewer's grains. The flow rate of air, water vapor WV, heavy particulates HP and particulate material P within gap 1072 is selected to be 1600 feet/minute at 4 psi for brewer's grains having a moisture content between 70% and 80%.

Funnel 1080 comprises straight shaft 1090 and funnel opening 1100, wherein straight shaft 1090 is disposed partially within upper section 1010, extending out of, and above, upper section 1010, and wherein funnel opening 1100 is disposed within upper portion 1040 of middle section 1020. Funnel 1080 is retained within upper section 1010 via positioning means 1120, wherein positioning means 1120 comprises retaining frame 1122, retaining rod 1123 and retaining nut 1124. End 1126 of retaining rod 1123 is disposed proximate indicia 1128, wherein the location of retaining rod 1123 proximate indicia 1128 indicates the position of funnel 1080.

Sides 1110 of funnel opening 1100 extend outwardly within upper portion 1040 of middle section 1020, and can be selectively positioned closer to, or farther from, top 1074 of conical baffle 1070 via positioning means 1120, thereby forming space 1112. For brewer's grains, space 1112 is preferably 4 inches.

Funnel 1080 comprises opening 1114, wherein water vapor WV and particulate matter P exiting from drying separator 1000 passes through opening 1114 exiting through top 1115, and wherein water vapor WV and particulate matter P can be selectively collected or dispersed. Upper section 1010 further comprises outlet 1300, wherein outlet 1300 is in communication with upper section 1010 and functions to permit recovery of heavy particulates HP as more fully discussed below.

For example particulate matter P, heavy particulates HP and water vapor WV formed from the impact of solid material SM against wall 1410 are carried via air from fan 96 into middle section 1020 of drying separator 1000 via gap 1072, passing around conical baffle 1070, thereby creating a cyclonic updraft within drying separator 1000. Heavy particulates HP, being denser than water vapor WV and particulate matter P, are carried outboard of funnel 1100 through channel 1116 into outlet 1300, passing therethrough and exiting opening 1310, wherein heavy particulates HP can subsequently be collected. By varying the height of conical baffle 1070 and the position of funnel 1080, the dwell time within drying separator 1000 can be selected according to the drying needs of the material under process.

Further, the shape and capacity of drying separator 1000 is selected such that a dwell time of approximately 45 seconds will result for brewer's grains having a beginning moisture content of 70 to 80% at a flow rate of 2 cubic feet per min of solid material SM (as a slurry). The longer the dwell time, the drier the heavy particulates HP, wherein volume, percent moisture, and amount of moisture to be removed, will require the selection of dwell time via varying flow rate of air and solid material SM. The selected air to material ratio depends upon material density and quantity of liquid to be removed, and is selected to be approximately 4000 to 7000 cubic feet air to 2 cubic feet material.

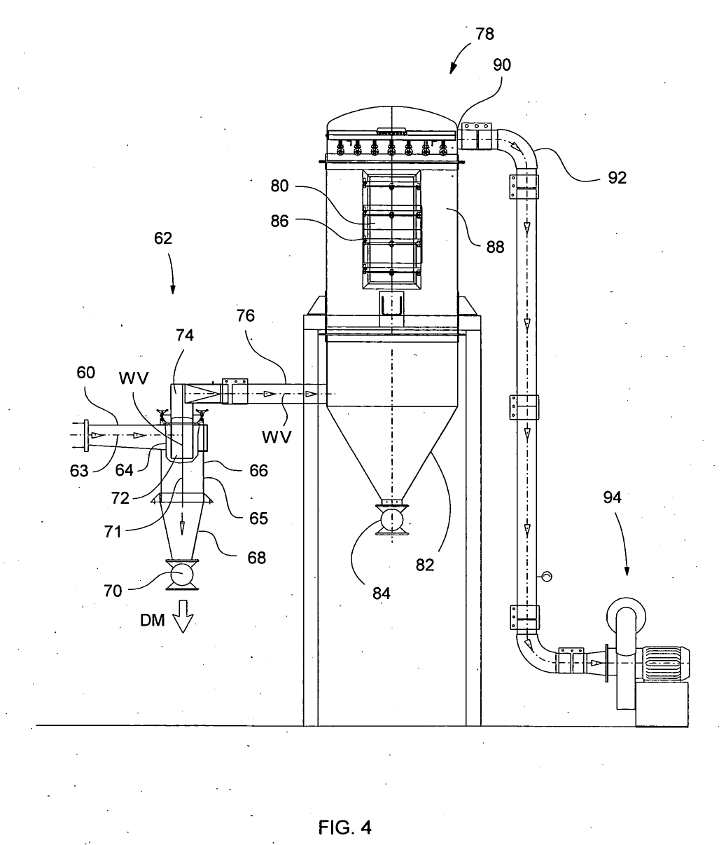

Water vapor WV and particulate matter PM migrates, carried by the air stream circulating within drying separator 1000, to the center of drying separator 1000 and, subsequently, water vapor WV and particulate matter PM are carried into funnel 1080, exiting therefrom and continuing to cyclone 62 (best shown in FIGS. 1 and 4), wherein separation of water vapor WV and particulate matter PM is implemented as described hereinabove. Particulate matter P preferably exits cyclone 20 through outlet gate 70 as substantially dry material DM. Water vapor WV, having a lower density than particulate matter PM, is less affected by centrifugal forces and. Therefore, drifts to center 71 of cyclone 62, wherein water vapor WV preferably exits cyclone 62 via center pickup 72 through top 74 into tube 76 to baghouse 78. Within baghouse 78, water vapor WV condenses and any residual particulate matter PM is collected.

In an alternate embodiment of the present invention, it is envisioned that tip 1230 and chamber 1240 could be replaced with a convergent/divergent nozzle, wherein the air flow passes through said convergent/divergent nozzle and solid material SM enters in the fully converged portion thereof.

It is envisioned in another alternate embodiment that a different device than atomization by steel plate 44 for classification/separation of atomized water could be utilized, such as, for exemplary purposes only, atomization via screen material, wherein particulates of small size would pass through correspondingly-dimensioned holes in a screen and out of the atomizing cylone, while larger particles would impact on the wires of the screen and be atomized.

It is contemplated in still another alternate embodiment that fewer or more cyclones could be utilized, wherein treatment could be sequentially decreased or increased.

It is contemplated in yet another alternate embodiment that the present invention could be utilized to separate dry particulate matter P of differing densities, wherein in lieu of water vapor WV collection, tube 76 would transfer the less dense dry particulate matter P for collection.

It is envisioned in a further alternate embodiment that apparatus 10 could be utilized for removal of any solvent from material to be dried.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing the steps of the method in a certain order does not constitute any limitation on the order of the steps of the method. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. Accordingly, the present invention is not limited to the specific embodiments illustrated herein, but is limited only by the following claims.

1. An apparatus for air classification and drying of particulate matter comprising:
means for carrying particulate matter; and
means for atomizing water.

2. The apparatus of claim 1, further comprising means for separating water from said particulates.

3. The apparatus of claim 2, wherein said means for separating classifies said atomized water and particulates.

4. The apparatus of claim 1, wherein said means for carrying comprises fluid flow.

5. The apparatus of claim 4, wherein said fluid flow comprises forced air.

6. The apparatus of claim 4, wherein said fluid flow comprises a slurry.

7. The apparatus of claim 1, wherein said forced air is propelled by a means selected from a high-pressure blower, stored air, a compressor, and combinations thereof.

8. The apparatus of claim 1, wherein said means for atomizing water comprises impacting water approximately normally against a solid plate.

9. The apparatus of claim 1, wherein said means for atomizing water comprises impacting moist solid material against a wall of a tube, wherein said tube carries flowing air.

10. The apparatus of claim 2, wherein said means for classifying comprises a cyclone.

11. The apparatus of claim 1, wherein said means for separating comprises specific gravity separation under centrifugal force.

12. The apparatus of claim 4, further comprising a convergent/divergent nozzle.

13. The apparatus of claim 12, wherein said fluid flow passes through said convergent/divergent nozzle.

14. The apparatus of claim 1, wherein said means for carrying comprises air, wherein said air is moved by a pushing force comprising a high-pressure blower and by a pulling force comprising an expelling fan.

15. A method of drying particulate matter, comprising the steps of:
a) flowing the particulate matter at a high rate;
b) atomizing water to vapor; and
c) separating water vapor from the particulate matter.

16. The method of claim 15, further comprising the step of:
impacting the particulate matter against a solid surface.

17. The method of claim 16, wherein said solid surface comprises a steel plate.

18. The method of claim 16, wherein said solid surface comprises a tube wall.

19. The method of claim 16, wherein said step of impacting comprises impacting said particulate matter approximately normal to the plane of said solid plate.

20. The method of claim 15, wherein said step of flowing comprises the steps of:
propelling air at a high velocity by pushing the air with a high pressure blower; and
expelling the air via a fan.

21. The method of claim 15, wherein said step of separating comprises the step of:
classifying the water vapor and the particulate matter within a cyclone.

22. The method of claim 15, wherein said step of separating comprises the step of:
allowing the particulate matter to fall under centrifugal force.

23. The method of claim 15, wherein said step of separating comprises the step of:
allowing the water vapor to rise in an air stream.

24. A system for elimination of water from solid matter comprising:
at least one source of high velocity air;
at least one solid matter feeder;
at least one conveying tube;
at least one moisture atomizer;
at least one cyclone; and
at least one classifier/separator, wherein moisture atomized by said at least one moisture atomizer separates from the solid matter.
